(19) United States
(12) Patent Application Publication
(10) Pub. No.: US 2011/0166883 A1
(43) Pub. Date: Jul. 7, 2011

(54) Systems and Methods for Modeling Healthcare Costs, Predicting Same, and Targeting Improved Healthcare Quality and Profitability

(76) Inventors: Robert D. Palmer, St. Louis, MO (US); Arthur Bertolero, Danville, CA (US); Amit Bhagat, St. Louis, MO (US); David Theodoro, (US); Maxwell Bertolero, New York, NY (US)

(21) Appl. No.: 12/874,033

(22) Filed: Sep. 1, 2010

Related U.S. Application Data
(60) Provisional application No. 61/238,987, filed on Sep. 1, 2009.

(51) Int. Cl. G06Q 50/00; G06Q 10/00

(52) U.S. Cl. 705/3; 705/2

(57) ABSTRACT

A comprehensive healthcare analytic and predicative modeling system that tracks costs for patients on a long term basis (greater than 6 months, one-year, or more) to assess the long-term effectiveness of various treatment options. Based upon the evaluation of the long-term effectiveness of various treatment options, the system then delivers a predictive model, which is based on data extracted and aggregated from dissimilar databases, that analyzes up-to-date economic and clinical outcomes, and then, using this data, can estimate long-term future treatment results from an economic and clinical perspective. Also disclosed herein is a personal electronic medical record on a computer network created by a medical provider on the authorization of the patient and controlled by the patient. Lastly, disclosed herein is a computer system for the consolidation of medical and financial data from disparate databases into a unitary data format.

### CROSS REFERENCE TO RELATED APPLICATION(S)

This Application claims the benefit of U.S. Provisional Patent Application Ser. No. 61/238,987, filed Sep. 1, 2009, the entire disclosure of which is herein incorporated by reference.

### BACKGROUND OF THE INVENTION

1. Field of the Invention

This disclosure is related to the field of comprehensive health care cost and outcome measurement systems that track costs for patients on a long-term basis to assess the long-term effectiveness of various treatment options. This disclosure is also related to the field of electronic medical records and computer systems for the aggregation and collation of medical data stored in multiple disparate databases.

2. Description of Related Art

Healthcare costs are skyrocketing. Healthcare spending has been estimated as being more than 15% of the GDP of the United States and one of the largest segments of the economy on which money is spent, totaling in at over 2 trillion dollars a year. Health insurance premiums have doubled in the last eight years, rising 3.7 times faster than wages. The resulting increase in co-pays and deductibles threatens access to care for many. Even with such large expenditures on healthcare, however, there are serious questions regarding the correlation of the amount of money spent on healthcare to the quality or necessity of the healthcare services received.

One key problem at the heart of rising healthcare costs is the inefficiency of the healthcare system. One-quarter of all medical spending goes to administrative and overhead costs. While the delivery of quality medical care demands that providers have access to necessary and trusted information at the right time and in the right format, the healthcare industry, unlike most other industries, has not implemented analytics and business intelligence technology advancements. Rather, to a large extent, the healthcare industry still relies on antiquated paper-based records and information systems which needlessly increase the cost of healthcare to the tune of billions of dollars every year as a result of their inefficiencies.

The communication and exchange of information in the healthcare industry is only further complicated by some of the inherent characteristics of the delivery of healthcare. Due to the multiple providers, services and payers involved, the healthcare industry is inherently fragmented. This fragmentation is only further complicated by inefficient or absent communication and increased provider specialization. These communication problems arise partly because of the antiquated way data is stored in different and incompatible formats: on paper, within inaccessible “silos” behind the firewalls of institutions, as tacit knowledge in someone's mind. This results in incomplete, inaccurate (i.e., wrong/out of date) or unclear communications. Despite decades of attempted automation, hospital service line information remains largely unchanged—fragmented, siloed and only intermittently automated.

One of the most serious problems with the antiquated record keeping utilized in the healthcare industry, or even in the areas where some form of information system is utilized in combination with the standard manual systems, is the impediment of the provision of important clinical information. The current practice in the healthcare industry puts an undue burden on clinicians, nurses and allied healthcare professionals to make complex and time sensitive decisions in high-pressure situations with lives on the line. Physicians are personally charged with compiling and analyzing information, having to continually update their knowledge on new treatments, procedures, devices and protocols covering thousands of different diseases and syndromes, medications, lab tests and articles in biomedical literature. The unaided human mind simply cannot process the current volume of clinical data required to provide care.

The current problem with clinical analyses is not the result of a shortage of data; healthcare organizations are generating more data than ever, in excess of 1,000 events per second for some high-volume streams. As exemplified in a 2009 report by the IDC, enterprise data volume has grown at a 52% compounded annual growth rate since 2005. The problem, rather, is that most of this information is not harvested or is used to late for anyone to benefit from it, due to the limitations of the manual systems and limited automation and IT applications in place in hospitals. In addition, this data is often stored in different formats making it challenging to efficiently analyze and gain insight without using powerful analytics solutions. The consequences of the data overload combined with lack of access to trusted information can lead to clinical decisions based on invalid or out-of-date information, leading to potentially disastrous consequences. For example, a large majority of adverse drug events (ADEs), a leading cause of morbidity in the U.S., can be attributed to information fragmentation and the lack of communication between providers.

The inability to efficiently and effectively analyze clinical information due to the inherent problems of the information storage and analytic systems used in the healthcare industry and the tardy updating of clinical information, amongst others, creates substantial gaps in the clinical care of patients. Those at greatest risk to fall into these “gaps” are patients with co-morbidities, where the issues of complexity and limited time available for careful assessment potentially lead to sub-optimal clinical practices and outcomes. A more efficient system for assimilating this information into clinical practice guidelines and accessing this information is needed.

Thus, what is required in the healthcare industry to obviate the problems inherent in the current practice of clinical analysis, is a system that is capable of analyzing large volumes of longitudinal data to reveal multivariable patterns. These applications need to be able to extract, transform and load this information from multiple sources and formats since the storage of this information is frequently fragmented and located in multiple sources and different formats. Further, the volume, frequency and complexity of clinical information require real time analytic and intelligence monitoring technology to make sense of these events. To provide scalability, traceability and accuracy, these analytic tools need to employ rule engines incorporating complex factors including risk, complications and new information that change the patient's expected outcome. Robust analytic and BI tools are also required to monitor the progression of events with automated alerts and to assist clinicians in breaking the chain of events that might lead to complications or mortality.

In addition to causing problems with the provision of important clinical information, the antiquated, fragmented, siloed and only intermittently automated systems for storing and providing hospital line information are also inefficient for determining if money is being spent wisely on a healthcare procedure or expenditure; i.e., for performing cost/value equations.

To at least some degree, the problem of healthcare spending arises from the difficulty in quantifying the “value” of healthcare. Econometrics provides a large number of methodologies to try and value intangibles, but the determination of the value of living without pain, living with improved mobility, or even living for an additional month can be problematic as these values can change from person to person, and within one person's lifetime. This is compounded by the issue of personal bias. One may value the ability to live without pain at a certain amount when they are discussing such a procedure for someone else generally, but may value it much higher when they are individually forced to live with pain every day.

While the valuation of any type of healthcare procedure can be difficult because of inherent biases in the system, many of these biases can be eliminated, or at least cancelled out, by looking at the cost of care in the aggregate to determine, at least, what is the most cost effective care. Thus, one can look across healthcare as a whole and determine what it costs to perform a procedure and the value of a procedure comparatively, even if it is difficult to determine what the value of the procedure is from an individual point of view.

At the same time, even this determination in the aggregate has proven elusive. Many hospital procedures involve slight differences from case to case. Thus, while one can say that a medical procedure involved X materials, Y time of a doctor, and a Z length hospital stay, it is difficult to say that same value will apply to the same medial procedure given to a different patient at a different location. Variable factors such as the cost of materials, patient complications, and regional healthcare market variations, amongst others, can render even the same medical procedures incomparable.

Thus, it can be very difficult for a hospital to determine if they are providing efficient healthcare services and which procedures represent more cost effective treatment. For example, one course of treatment may be more cost effective for patient A, while a second may be more cost efficient for patient B. Further, hospitals and health centers do not all cater to the same patients. There is geographic variation on the types of cases which the hospital sees dependent on its potential patient population. Thus, in one area of the country, certain procedures related to certain care may be less expensive because more are performed than elsewhere.

Accordingly, the delivery of cost-efficient quality medical care demands access to information at the right time and in the right format. Currently, many health practitioners, hospital CFOs, controllers, business managers and other healthcare administrators who are performing these cost/value analyses turn to spreadsheets for assistance in cost calculations and determinations. Unfortunately, spreadsheets are not adequate tools to do this important work; they were not designed to facilitate interactivity, aggregation or multi-dimensional analysis of data for decision-making. In addition, the complexity of the analysis required to support healthcare has increased to the point where longitudinal, multi-variable analysis and data-management requirements have exceeded the capabilities of spreadsheets. Spreadsheets simply were not designed for creating larger, multi-dimensional business and financial models. Indeed, most spreadsheets have a hard stop at 256 columns and 65,000 rows. Even before hitting the physical size restrictions, the performance of most models will deteriorate due to the sheer number of formulas and calculated cells. Large models often have very long calculation processing times and quickly become unstable.

These inherent problems in spreadsheet technology result in many problems. Individuals must spend a large proportion of their time searching for data or creating/working with the spreadsheets. They are also charged with making crucial decisions relying upon spreadsheets that are developed by others. Often, these spreadsheets contain hidden errors and inaccuracies that can lead to bad decisions. Spreadsheets are often shared and edited by numerous parties, resulting in multiple versions of similar material. The variation in drafting causes inconsistencies in analysis, an inability to audit workflows and significant data reliability challenges. Furthermore, the spreadsheets lack sophisticated data security features and can cause data security and confidentiality challenges.

Further, as previously alluded to, the healthcare business is complex, requiring the analysis of multi-dimensional issues and unknowns from both a clinical and a business perspective. However, with the current information systems utilized in the healthcare industry, there is no efficient or reliable way of determining the projected revenue and cost compared to quality and necessity for providing a service at the time the service is provided. This is one of the reasons why, historically, both public and private insurers have paid providers based on the volume of services provided, rather than the quality or effectiveness of care and, consequently, hospitals have defined their business models and strategy based upon volume.

However, recent political and business pressures are forcing providers and payers, including the United States Government, to utilize new innovative ways to develop and disseminate best practices and align reimbursement with the provision of high quality health care; i.e., to take the economics of provision and reimbursement of healthcare services out of simply a volume-based matrix.

Thus, market forces and political pressures are demanding that healthcare providers begin to utilize appropriate and reliable data and complex analytics to enable improved efficiency and quality. However, as noted herein, the antiquated systems utilized by the healthcare industry for performing these analyses are insufficient, inadequate and problematic. New ways to align incentives and define performance based on both outcomes and cost initiatives are needed. Thus, there is a need in the healthcare industry for integrated information management processes and systems supported by robust analytics and BI tools to define the cost of an incidence, predict exposure and better align incentives and decrease occurrences. There is also a need for differential models that allow for the testing of different potential scenarios and the reduction of risk from the employment of new methods, protocols, devices and drugs to determine the expected impact on key clinical and economic measures.

### SUMMARY OF THE INVENTION

Because of these and other problems in the art, described herein, among other things is a computer-readable memory storing computer-executable instructions for storing and accessing a patient's personal medical record on a computer network. The computer-readable memory comprises computer-executable instructions for storing a dataset comprising a personal medical record of a patient created by a medical provider on the patient's authorization with the personal medical record being controlled by the patient; computer-executable instructions for identifying a user trying to access the personal medical record as the patient; computer-executable instructions for allowing the patient to review, add to and modify the personal medical record after access to the personal medical record is granted to the patient via a network; computer-executable instructions for allowing an interested party to request access to the personal medical record from the patient; computer-executable instructions for allowing the patient to accept the request for access to the personal medical record, wherein if the request is accepted, then the interested party can access, add to, and modify the personal medical record; computer-executable instructions for allowing the patient to revoke access to the interested party after the request has been accepted, wherein if the access is revoked, then the interested party can no longer access, add to, and modify the patient's personal medical record.

In an embodiment of the computer-readable memory storing computer-executable instructions for storing and accessing a patient's personal medical record on a computer network, the interested party is a physician, a healthcare practitioner, a health insurance company, a hospital or a healthcare facility providing medical care to said patient.

In another embodiment of the computer-readable memory storing computer-executable instructions for storing and accessing a patient's personal medical record on a computer network, the dataset comprising the patient's personal medical record is created when the patient first visits the interested party and the personal medical record id created by the interested party at a point of care.

In one embodiment, the memory further comprises computer-executable instructions for automatically updating the personal electronic medical record with information relevant to the patient from a database associated with the interested party. Similarly, in another embodiment of the memory, the personal electronic medical record is passively updated with medical information relevant to the patient from the third-party database without an action being taken by the patient or the interested party.

The memory is also comprised, in one embodiment, of computer-executable instructions for transmitting non-personalized information from the patient's personal medical record to a third-party database.

In another embodiment of the memory, the memory further comprises computer-executable instructions for providing the patient access to a premium level of services. IN this embodiment, the patient will receive access to the premium level of services if the patient pays a monetary fee.

In a final embodiment of the computer-readable memory storing computer-executable instructions for storing and accessing a patient's personal medical record on a computer network, the memory further comprises computer-executable instructions for receiving an invoice from the interested party; computer-executable instructions for determining which portion of the invoice is the responsibility of the patient and which portion of the invoice is the responsibility of a third party payer; computer-executable instructions for storing payment information of the patient, the payment information of the patient being either a credit card, a bank account, a money order, and an e-commerce payment account; and computer-executable instructions for automatic payment of the patient's portion of the invoice with the payment information of the patient upon the receipt of the invoice.

Also disclosed herein is a computer system for the consolidation of medical and financial data. In one embodiment, the computer system comprises a medical database accessed by a first computer; a financial database accessed by a second computer; a third computer connected to the first computer and the second computer by a network; a data warehouse accessed by the third computer; a medical data set stored in the medical database; and a financial data set stored in the financial database; wherein the third computer requests the medical data set from the first computer over the network and the financial data set from said second computer over said network; wherein the first computer retrieves the medical data set from the medical database and the second computer retrieves the financial data set from the financial database; wherein the first computer and the second computer transmits the medical data set and the financial data set to the third computer; wherein the third computer receives the medical data set and the financial data set; wherein the third computer automatically transforms the requested data sets into a unitary data format and the second computer automatically associates data contained in the requested data sets with a classification corresponding to a specific medical procedure to create a final data set; wherein the third computer stores the final data set in the data warehouse; and wherein the final data set is retrievable from the data warehouse by its classification.

In one embodiment of the computer system described above, the classification of the data corresponds to a medical service line. In another embodiment, the classification corresponds to a Medicare Severity Diagnosis Related Group (MSDRG).

In another embodiment of the computer system, the third computer requests a plurality of data sets from a plurality of databases, a plurality of data sets from the plurality of databases are transmitted to a third computer, the third computer receives the plurality of data sets and aggregates the plurality of data sets after the third computer transforms the plurality of data sets into a unitary data format. The plurality of databases can contain clinical data, financial data, diagnostic images, published medical evidence and historical data.

Also disclosed herein is a computer-readable memory storing computer-executable instructions for an analytical and predictive modeling system on a computer network, the memory comprising: computer-executable instructions for capturing data sets from a plurality of databases; computer-executable instructions for transforming the captured data sets into a unitary data format, the unitary data format associating the captured data sets with a classification corresponding to a specific medical procedure; computer-executable instructions for collecting multiple data sets associated with classifications corresponding to a service line into an amalgamated data set; computer-executable instructions for analyzing the single data set to produce a predictive model for average and best practices for the service line; computer-executable instructions for receiving an individual provider's input variables in a unitary format for the service line; and computer-executable instructions for comparing the predictive model to an individual provider's input variables to produce a decision tree for the service line for an individual provider. The plurality of databases used by the analytical system can contain clinical data, financial data, A level data and historical data. Further, in one embodiment, the decision tree is comprised of benchmarks, actual output and target output and Monte Carlo simulation is used to produce the decision tree.

In one embodiment, in the step of analyzing the following factors are considered: expected patient population, frequency at which a procedure is performed, cost of a procedure, service line, population yield, average length of stay, volume of procedures, revenue of provider per procedure, direct costs to provider, and contribution profit of the provider.

In another embodiment, the step of analyzing the data set is performed to produce a predictive model for average and best practices for an individual clinician and patient at the point of care, with recommendations for treatment.

In a final embodiment of the analytical and predictive modeling system, the decision tree is comprised of benchmarks, actual value and target values in the preoperative, intraoperative and post operative stages of a specific medical procedure for the individual clinician.

### BRIEF DESCRIPTION OF THE DRAWINGS

FIG. 1 provides a general flow diagram of data in an embodiment of the disclosed analytic and predictive modeling system.

FIG. 2 provides a flow chart of an embodiment of a methodology for analysis of the disclosed analytic and predictive modeling system.

FIG. 3 provides a flow chart of an embodiment of an econometric analysis employed by the disclosed analytic and predictive modeling system.

FIG. 4 provides a sample determination of yield analysis for a single procedure.

FIG. 5 provides a partial display of the benchmark output of current cost performance against expected performance and targeting of future goals for a variety of procedures of the of disclosed analytic and predictive modeling system.

FIG. 6 provides a partial display of the benchmark output of current quality performance against target and benchmark performance for an individual medial practitioner for an individual procedure.

FIG. 7 provides a sample benchmarking comparison output for an individual medical provider for an individual medical procedure.

FIG. 8 provides an embodiment of a portion of a decision tree illustrating determination of the type of procedure for disclosed analytic and predictive modeling system.

FIG. 9 provides a general block diagram of an embodiment of the disclosed data aggregate system.

FIG. 10 provides a general block diagram of an embodiment of the disclosed data aggregate system.

FIG. 11 provides an embodiment of a general block diagram of patient care selection utilizing a Personal Electronic Medical Record (PEMR).

FIG. 12 provides an embodiment of a general block diagram for the creation of a PEMR.

FIG. 13 provides an embodiment of a general block diagram for integrated billing using a PEMR.

FIG. 14 provides an embodiment of a screen shot of the home screen from an embodiment of a PEMR online user page.

FIG. 15 shows a general block diagram illustrating overlap of information between various different entities in an embodiment of a PEMR.

### DESCRIPTION OF THE PREFERRED EMBODIMENT(S)

Described herein, among other things, is a comprehensive healthcare analytic and predicative modeling system that tracks costs for patients on a long term basis (greater than 6 months, one-year, or more) to assess the long-term effectiveness of various treatment options. Based upon evaluation of the long-term effectiveness of various treatment options, the system then delivers a predictive model, which is based on data extracted and aggregated from dissimilar databases, that analyzes up-to-date economic and clinical outcomes, and then, using this data, can estimate long-term future treatment results from an economic and clinical perspective.

The system can be used to assist hospital executives, physicians and other individuals involved or interested in the healthcare industry in forecasting, decision-making, planning and to closely monitor various performance measures to make sure key performance targets are being met by the healthcare facility as a whole and by individual doctors therein. It also can be used to provide for regional, national, or global indicators of the effectiveness of certain treatments to enhance care over a large area. The system also has applications for insurance companies and payers such as, but not limited to, Medicare and Medicaid.

The analytic and predictive modeling system disclosed herein employs advanced modeling and quantitative techniques to forecast the impact of evolving technologies, changing client preferences and shifting populations. The system can be used to generate a strategic business plan to improve operations, and to allow effective monitoring of various performance measures of a healthcare service line. This is accomplished by employing a more comprehensive approach to maximizing service line performance, increasing revenue, and explicitly considering the consequences (both economic and financial) for improving care.

The analytic and predictive modeling system disclosed herein has the ability to determine population yields to certain medical procedures and compares the costs and clinical outcomes associated with certain medical procedures to both national and best-in-class hospital benchmarks. The system also employs scenario modeling for variables that are subjective, ambiguous or uncertain and uses sensitivity analysis to establish the extent to which variations in specific assumptions influence outcomes. By raising and testing various “what-if” questions, users of the disclosed system can consider and plan for different potential outcomes resulting from a variety of operating strategies and economic conditions. Further, the system provides users with a system and tools with which they can brainstorm and challenge their assumptions in a risk-free, hypothetical environment to stress-test plans and forecasts to develop a well-informed view of the future.

Generally, the systems discussed herein will comprise computerized analytical systems comprising one or more processors designed to work together to produce a coherent computing system. The system may be contained on a single machine or distributed across a network, although the network will generally be preferred. The computer system will have access to computer readable memory (such as, but not limited to, a hard disk, floppy disk, or non-volatile memory device) which may be local or remote which includes instructions for instructing the computer system to carry out the methods and analysis discussed herein by providing computerized modeling and prediction based upon those instructions. The computer will generally then provide output to a user which that user can either use as is (that is the computer can predict likely outcomes or provide for targets based upon its analysis), or the computer can provide more raw data upon which a human user can provide further computation or analysis in order to provide for forecasting or modeling. As used herein, the term computer includes both traditional desktop and laptop computers, in addition to any number of output devices including, but not limited to, an e-book reader, a Smartphone, or a Personal Digital Assistant (PDA). These devices can be used alone or in combination. The system will also generally include computer accessible databases and data wave houses of stored information which can be accessed by the processor(s) to carry out the systems and methods disclosed herein.

The analytic and predictive modeling system disclosed herein generally utilizes five (5) related decision products that combine algorithms and analytic methods incorporating econometric yields, financial comparables and market forecasts. In the system, this analytic framework is used in combination with predictive models to forecast scenarios and produce both standard and customized analytics that have the ability to better predict demand and practice patterns; create business budgets and plans; align incentives; define key performance indicators (KPIs) and allow a user to develop a well informed view of the future. This combination of mathematical and statistical modeling methods with computational techniques creates new tools to assist users to make informed decisions from a plurality of choices and distributions of probable outcomes. The generated outcomes can be used to summarize by graphical, by exploratory data analysis, and by other methods, systems or means known to those of ordinary skill in the art to provide data in a useable form.

The five (5) related decision products that are utilized in concert by the disclosed analytic and predictive modeling system are econometric modeling, predictive planning and budgeting, KPI, alignment of incentives and predictive medicine.

Econometrics involves the formulation of mathematical models to represent real-world healthcare systems, whether that system be at the level of the whole market, an individual hospital or an individual physician. The ultimate application of econometrics is the creation of a comprehensive model of a market or a practice area so that the interaction of all economic variables can be understood and predicted. Econometric modeling analyzes complex market trends to determine the variables driving the growth or decline of demand and to decipher the economic forces that affect supply and costs within an industry. This econometric modeling leads to a broader and more comprehensive understanding of market drivers and sensitivity. It is also able to identify significant underlying relationships between critical internal/external factors and variables and can quantify the factors that drive quality and profitability on the procedural level. Thus, the econometric modeling aspect of the disclosed analytic and predictive modeling system provides users of the system with the ability to anticipate the impact of emerging technology on their organizations, including health-system demand and capacity requirements.

The second decision product used by the analytic and predictive modeling system is predictive planning and budgeting (PPB). PPB is based upon predictive analytics. PPB works on the procedural level to understand and determine the revenue and cost of individual medical procedures and treatments. PPB uses this revenue/cost determination for individual procedures as the basis for benchmarking and Web-based planning and collaboration tools that support shared data and iterative planning, link plans to performance, enable dynamic planning as external factors change and to monitor progress towards performance goals. In this way, the PPB aspect of the disclosed analytic and predictive modeling system disclosed herein enables hospitals and other healthcare organizations to determine which procedures and resources are increasing their profitability and which are contributing to their losses. This information can then be utilized to create a better, more efficient budget and to gain a greater overall understanding of the expenses that are required to keep the organization running smoothly.

The third decision product used by the analytic and predictive modeling system is KPI development. The system benchmarks information from a database to assist a user in identifying KPIs including clinical, yield and economic analysis. Mathematical models, including but not limited to, data mining, segmentation, clustering, regression modeling, market-basket analysis and decision trees, are employed to predict future behavior based on the current and historical data which is benchmarked from the database. Thus, KPIs are transformed from historically static, inexact measures to engineered, dynamic real-time enterprise metrics that will enable users to check on all aspects of their company to guarantee that they are making the correct decisions. Further, from this information, users will be able to balance business performance across entire organizations.

The fourth decision product used by the analytic and predictive modeling system is aligned incentives. Currently, the healthcare industry commoditizes physicians by reimbursing them the same amount regardless of where a physician is trained, what level of innovation is being achieved, the extra efforts being made towards improving quality, realization of better outcomes, or marginal economic benefit. Typically, clinicians have neither the incentive nor the authority to find ways of delivering care more cost-effectively. Properly incentivized clinicians could drive effective care while increasing operating margins through improving labor productivity, clinical resource utilization, supply costs, physician preference items (PPIs) expenditures and purchase services expenses. By aligning the incentives of patients, physicians and hospital staff, the analytic and predictive modeling system has the ability to promote collaborative and evidence-based care across different medical practice groups. It accomplishes this by managing high performers, especially highly elite professionals, with customized approaches. The system facilitates a team approach by combining well-honed analytical, presentation and negotiation skills in discussions with executives, physicians, suppliers or other critical audiences to synthesize an optimization plan and employ the tools required to attain the goal. The essential tools to achieve this optimal performance are a defined process, clear incentives, open communication, transparent measures and scheduled progress updates made possible by the merging of technology and operational processes; all tools which are available and provided by the disclosed system.

The final decision product used by the analytic and predictive modeling system is predictive medicine. The system supports clinicians with decision support systems to provide timely access to trusted information and alerts derived from streaming, current information. It predicts state changes and triggers an analysis used to alert and notify the proper authority that action must be taken. By utilizing event driven, multivariable and time series data analysis combined with predictive modeling, the system has the ability to provide a framework for success that hospitals or other healthcare institutions can follow to ensure they are taking correct steps in helping patients. The analytic and predictive modeling system disclosed herein accomplishes this by working with historical data to analyze anomaly events derived from operational systems and warehouses. It also allows for real-time action sequences based on current information. By utilizing different sources of information, the analytic and predictive modeling system can contribute to an understanding of sub-optimal outcomes, complications or mortality, and prevent them from happening again in the future. Predictive modeling can determine from the combination of events that occurred the root cause of the sub-optimal outcome, complication or mortality, leading to better value and/or better care for a patient. Through risk algorithms and the capability to send an alert when combinations of controllable events are converging to create the potential for an adverse outcome derived from an anomaly event, the analytic and predictive modeling system provides physicians and caregivers time series and event-driven information regarding risk trending. Further, by accessing real-time data information about a patient's health, the disclosed system will become activated when thresholds are exceeded and notify the proper user. The system's extensive database of clinical information relating to complications, mortality, and the factors that are correlated to both of these enables the system to examine, with great accuracy, what steps should be taken in order to prevent many of the problems that currently plague hospitals.

To illustrate the invention in a more tangible manner (i.e., in application) this disclosure utilizes a transparent measure in the equilibrium cath lab yield as a benchmark measure of current practice patterns, so executives and physicians (and insurance companies or Medicare) at the local level can determine if they are in or out of the normal range. However, it should be recognized that the systems and methods of the present application can be used for any type of procedure in any type of medical practice or specialty. The application of the system to cath lab yield is simply exemplary, allowing for a more detailed description of the elements, properties and functions of the disclosed system. Further, while the embodiments discussed herein will generally be used at a hospital or similar large healthcare center, it should be recognized that any institution, or collection of institutions, which would want to improve the care provided to patients could utilize the systems and methods discussed herein.

Further, in a number of places, the disclosure will utilize the term and discuss the concept of a “service line.” Due to requirements of greater transparency on cost and quality, intensified competition from specialty care providers, and continued workforce shortages, hospitals are increasingly focusing their efforts on such “service lines.” These services lines generally relate to categorizing various types of health care which serve specific types of related populations and are related in specialties and practice together to allow the multitude of interrelated and alternative procedures they perform to be roughly categorized. Some examples of typical service line classification include, but are not limited to, Orthopedics, Neuro-Sciences, Cardio-Thoracic (including vascular), Cancer Care (Oncology), Women's Health, and Geriatrics. In addition to applying the disclosed analytic and predictive modeling system to the particular procedure of a cath lab yield to provide a more tangible example of how the system works, the system will also be applied to different specific service lines to illustrate how the predictive capabilities of the system can benefit service line decision makers.

The analytic and predictive modeling system derives its data from the employment of a combination of statistical analysis and domain expertise to identify data patterns and relationships by identifying critical economic and clinical data supported by “A level” clinical evidence, econometric data and reimbursement data that is continuously updated. “A level” clinical evidence, as that term is used herein, means data from clinical trials such as, but not limited to, peer-reviewed randomized clinical trials published in journals such as the New England Journal of Medicine. In addition to utilizing relevant economic and clinical data, in certain embodiments, historical data is also used to visualize growth trends of a service line by market, by region, by hospital, by service line, by sub-service line, by physician, or even by procedure.

No currently employed method, system, product, algorithm, or device is known that takes empirical clinical and financial data, and aggregates (collecting data from various locations and combining the data into one usable accessible data base) the data before combining it with A level clinical evidence in order to predict financial and clinical outcomes for a specific patient, patient population (e.g., over 65 Medicare, Coronary Artery Disease, and Heart Failure, Atrial Fibrillation, etc.), hospital, group or system of hospitals, or national health care system, for a specific disease or combination of diseases. The analytic and predictive modeling system described herein, in an embodiment, is generally based on a database that contains a combination of empirical data on one or more medical procedures (data that is obtained from sources such as the New York State database where all cardiac surgeries are reported), A level clinical evidence and historical data. By combining evidence from multiple dissimilar databases (which often include results from studies in which all corners were reported on since they may include all such procedures performed by a reporting entity) and with A level evidence and historical data, the disclosed analytic and predictive modeling system provides a tool for managing and predicting best practices in the management of a disease from both a cost and outcome perspective.

While the above has examined the problems associated with the current information analyses in the healthcare industry at a high level, it should be readily apparent that the analytic and predictive modeling system disclosed herein provides for an aggregation and analysis of information not previously available. The system will now be described on a more detailed basis utilizing a specific line issue, cath lab yields.

By way of background, it is noted that today, a patient may be treated for multi vessel Coronary Artery Disease (CAD) by stents (catheter procedures) or Coronary Artery Bypass Graft surgery (CABG). In the real (for profit) world a patient may have two, three or even four catheter interventions with a cost of $40,000-80,000 (DRG 246-251) and ultimately have a CABG procedure with a cost of $41,000 (DRG 231-236) for a total treatment cost of $81,000-121,000. This information regarding the number, sequence, cost and timing of procedures constitutes the empirical data collected and contained in the database of the analytic and predictive modeling system.

Notably, the level A clinical evidence on CAD would often support a different treatment for a patient. Specifically, the clinical evidence in the above situation would support that the patient should have been treated with just a CABG, bypassing the cost (and increased risk) of the multiple catheter procedures. This could result in a saving of $40,000-80,000 for the patient or the entity paying his medical bills in addition to bypassing the stress associated with multiple surgical procedures. This information from clinical studies regarding the affect of a number, type or sequence of medical procedures on a patient or patient population is the level A data of the analytic and predictive modeling system.

Furthermore, today, most medical data on outcomes from surgical procedures such as catheter procedures or CABG are reported by hospitals and doctors based on observations at the time of discharge and then thirty days following discharge. However, to accurately assess total cost and outcomes, data must be collected for two to five years to determine long term morbidity, reoccurrence, and ultimately the success of a particular procedure for a particular patient or patient population. The information regarding the historical outlook of a given procedure on a given patient population is the historical data contained in the database of the disclosed analytic and predictive modeling system.

The disclosed system utilizes this empirical/level A/historical based data from disparate databases as the foundation for the predictive analytic techniques employed by the system which provide: continuous tracking of key performance indicators crucial to identifying deviations from plan as well as enabling the celebration of successes where performance exceeds plan, a reliable stream of performance data that enables the organization to focus on the right areas of development and that is also useable for performance-based conversations, efficient data collection processes and reliable data storage and management solutions, and user-friendly access to the information.

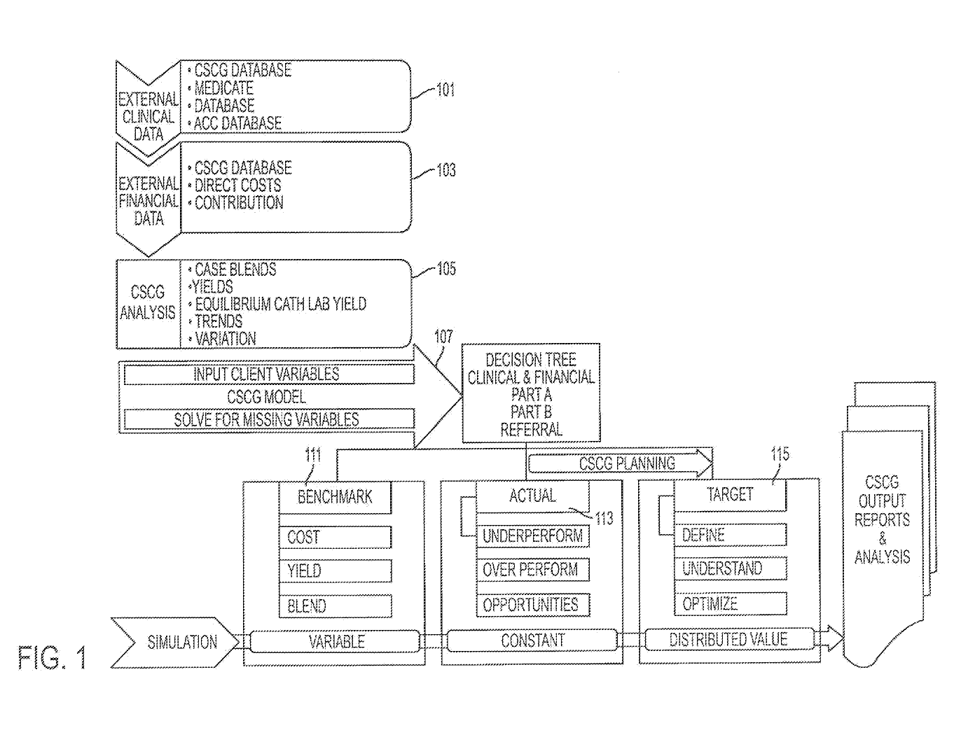

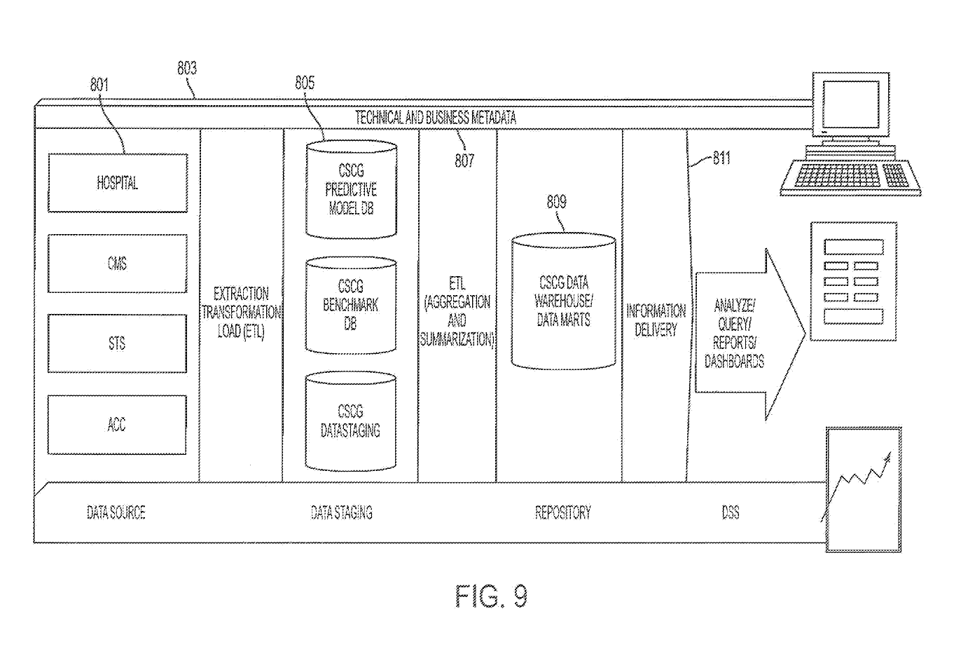

FIG. 1 provides for a general overview of an embodiment of the analytical and predictive modeling system. Specifically, it shows how a variety of external clinical (101) and financial (103) data (i.e., empirical data) is obtained for storage in the database and, ultimately, use in the predictive analytic techniques employed by the system (which will be further described later in this disclosure). As discussed previously, it is important that the empirical data is obtained from a wide variety of sources to generally eliminate any internal biases that may be present in any particular dataset. Further, in addition to obtaining data from multiple sources, in certain embodiments A level and historical data is also obtained and stored in the database. Once the data is obtained and coalesced into a coherent single data source, the data is analyzed (105) to produce metrics which correspond to best practices for outcomes and financial success. Effectively, the data is used to locate providers who already are obtaining better than average results. The collection and analysis of the data generally comprises the use of data warehousing techniques known to those of skill in the art such as, but not limited to, those shown in FIG. 9. Once the analysis has been performed, a general predictive model can be produced which shows average as well as best practices disclosing parameters such as case blends, yields, trends and variations.

Data from a specific hospital or other healthcare provider regarding a specific patient's circumstances and condition is then input into the system (107), generally in the same manner that external data was placed (and this data can be stored for later aggregation with existing data to further refine and augment the underlying data set). The specific provider's data is then compared to the general predictive model produced in step (105) to produce a decision tree (109). Generally, the decision tree is comprised of three classes of information: benchmarks (111), actual output (113) and target output (115).

The benchmarks (111) will generally provide for indicators of the number of each specific type of procedure performed, the cost that that procedure should cost to perform, the quality of the procedure (e.g., success in treatment or mortality) and/or a blend of such numbers for the industry as a whole, similar healthcare providers or the provider of interest. Thus, the benchmarks include, but are not limited to, cost, yield and blend for a certain medical procedure for an identified group.

The actual output (113) is the information regarding the circumstance of the particular patient or medical facility being analyzed. The actual output (113) of the provider is then compared against the benchmarks (111). This comparison provides an analysis of where the provider is succeeding (e.g., they may provide a particular procedure at a lower cost and perform more of them than a comparable hospital) and where they could use improvement. From this comparison, target output values (115) are determined. The target output values demonstrate to a provider where cost savings should be realized and in which circumstances additional procedures should be performed. Stated differently, the target values illustrate to a provider what changes need to be implemented in their practice such that the benchmark values can be met.

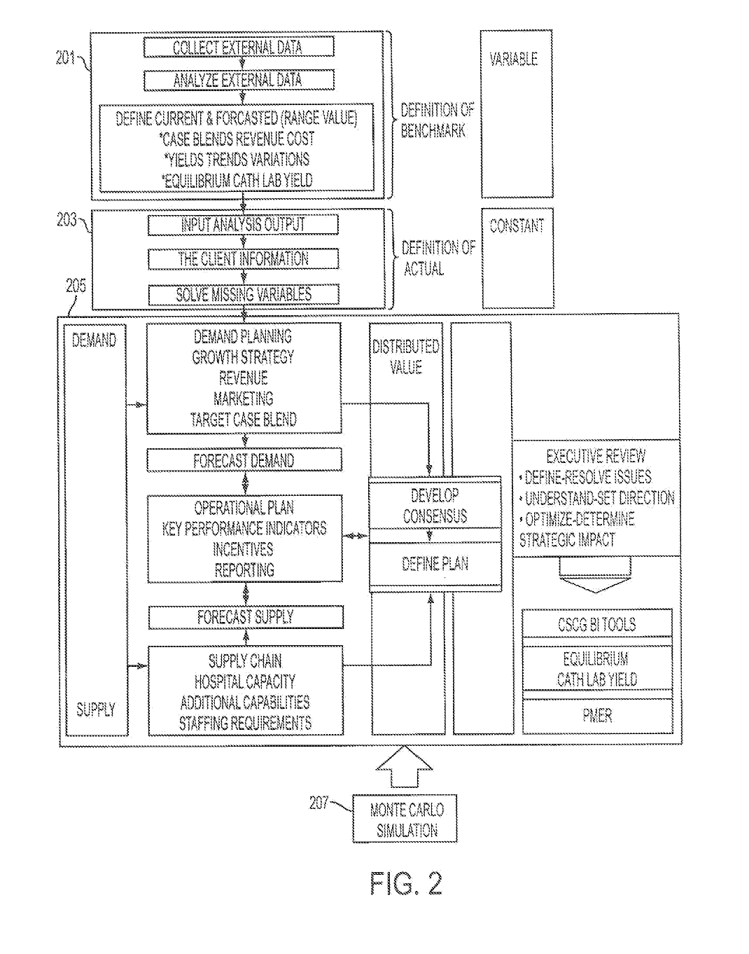

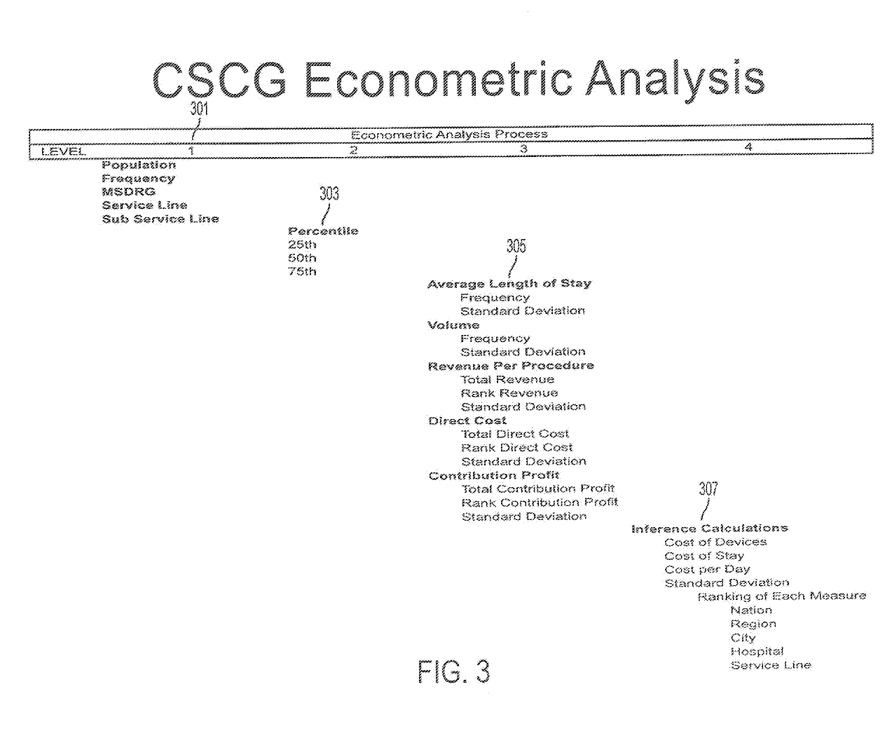

FIGS. 2 and 3 provide for a general overview of the predictive analytic techniques which may be used by the system to perform the econometric analysis to determine benchmarks (11) and to model goals. In a preferred embodiment, the analytical and predictive modeling system utilizes econometric analysis to provide robustness and to put numbers to previously ill-defined values. As can be seen in FIG. 2, in a first step (201), data from disparate external databases, including empirical A level and historical data, is collected. Then, the collected data is analyzed in order to define and create current and forecasted range values; the benchmark data (111) described previously. These values include, but are not limited to, case blends, revenue, cost, yields, trends, variations, and the equilibrium cath lab yield. Next, in a second step (203), the specific inputs for the provider are collected (203). This is the actual output (113) described previously. In a third step (205), the specific inputs for the provider are compared to the benchmarks to provide an econometric analysis for the user to determine the best places for growth and improvement, as described previously. This analysis may be performed using a variety of tools know to those of skill in the art. In one embodiment recognized simulation methods, such as the Monte Carlo simulation (207), are used to assist in the forecasting performed in step (205).

FIG. 3 provides a general overview of some of the factors that go into consideration during the econometric analysis of the data from the disparate databases to create benchmarks and their depth of consideration. At the first level (301), the basic divisions such as, but not limited to, expected patient population, the frequency at which the procedure is performed, cost of the procedure and service line are determined. A “population yield” is considered for the various procedures. This yield can be adjusted due to population differences including age, demographic tendencies and other factors that might influence propensity towards a given condition, treatment, or disease for the patient population a provider will be drawing from. For example, in an area with an older average population, procedures more commonly performed on the elderly would be expected to have an increased prevalence. From this yield a frequency rate distribution and standard deviation can be calculated. The population yield is a method of benchmarking, normalizing or holding constant procedures when solving for missing variables or defining procedures that are under or over performing.

In some cases, it is contemplated that there may be multiple population groups. This is the case when there are programs that have a regional or national reach in the specialized aspects of their service line (for instance, because of national recognition in that area) while in others (typically the emergent or commoditized procedures) the reach is localized. The use of a specific medical procedure, such as, but not limited to, MSDRG procedures as a classification in level 1 (301) acts as a safeguard to provide that similar procedures are compared. These procedures are transferred to the hospital classification of service line, which generally varies by provider so that data are logical for them.

In the second level (303), providers are classified into percentiles. This classification may be performed in similar manner to current methods of classification used by Medicare/Medicaid and well understood to those of ordinary skill The classifications are generally dependent on factors such as, but not limited to, the location, volume, teaching, and capabilities, among other things, of the particular provider.

The next level (305), provides for ranking internally and externally and a comparative analysis against benchmarks based both on comparable providers and against benchmarks and centers of excellence. Some of these measures include, but are not limited to, average length of stay, volume of procedures, revenue of the provider per procedure, direct costs to the provider, and contribution profit of the provider.

As a result of performing the first three levels of econometric analysis, in the fourth level (307) the system can perform inference calculations estimating the provider's comparative costs associated with the following: cost of devices (and other consumables) used in a procedure, cost of the hospital stay and cost per day for the patient. In an embodiment, it is also possible to rank each measure and estimate a standard deviation at the following levels: national, regional, city, hospital/provider, service line.

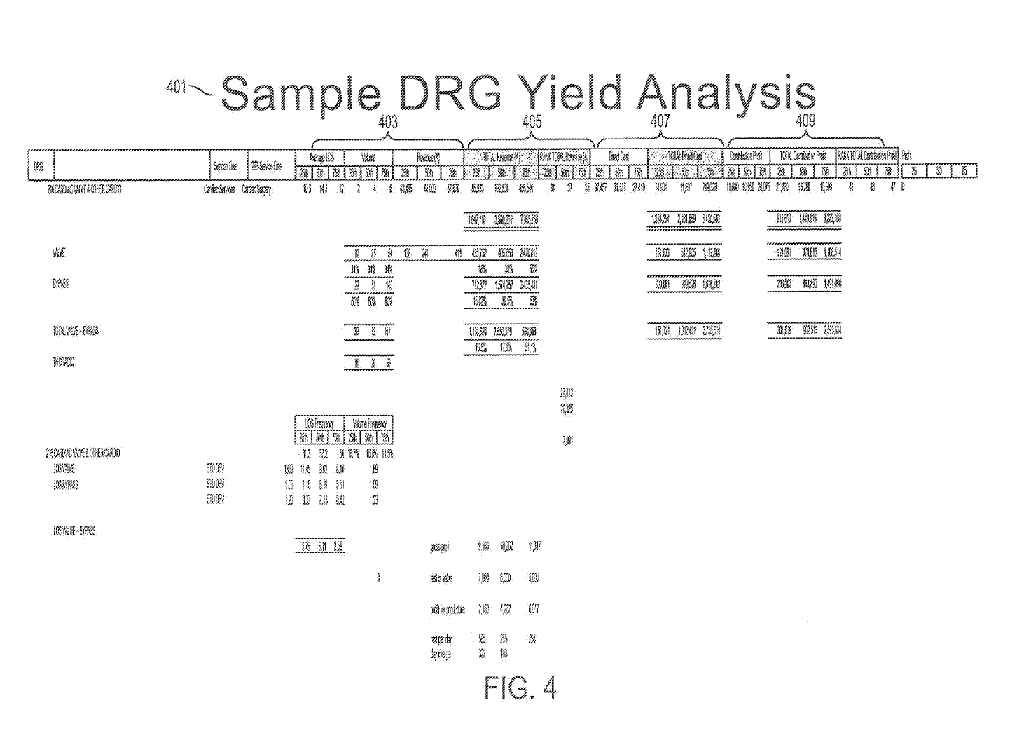

For each specific medical procedure, a yield analysis (401) can be determined. A specific medical procedure, as that term is used herein, includes a medical procedure classification or classification system known to those of skill in the art, including, but not limited to, classification by Medicare Severity Diagnosis Related Group (MSDRG). One example of this yield analysis for a MSDRG (216) procedure (Cardiac valve with cardiac cath) is shown in FIG. 4. In FIG. 4, the calculated averages from the level 3 (305) evaluations for the provider are shown (403), along with revenues (405), cost (407) and contribution profit (409). It should be recognized that FIG. 4 only provides one of a large plurality of procedures for which such outcomes will generally be created. It, therefore, is simply the output for a single exemplary procedure. It should be recognized that in the analysis performed by the analytical and predictive modeling system of the present invention, multiple such individual calculations will be performed.

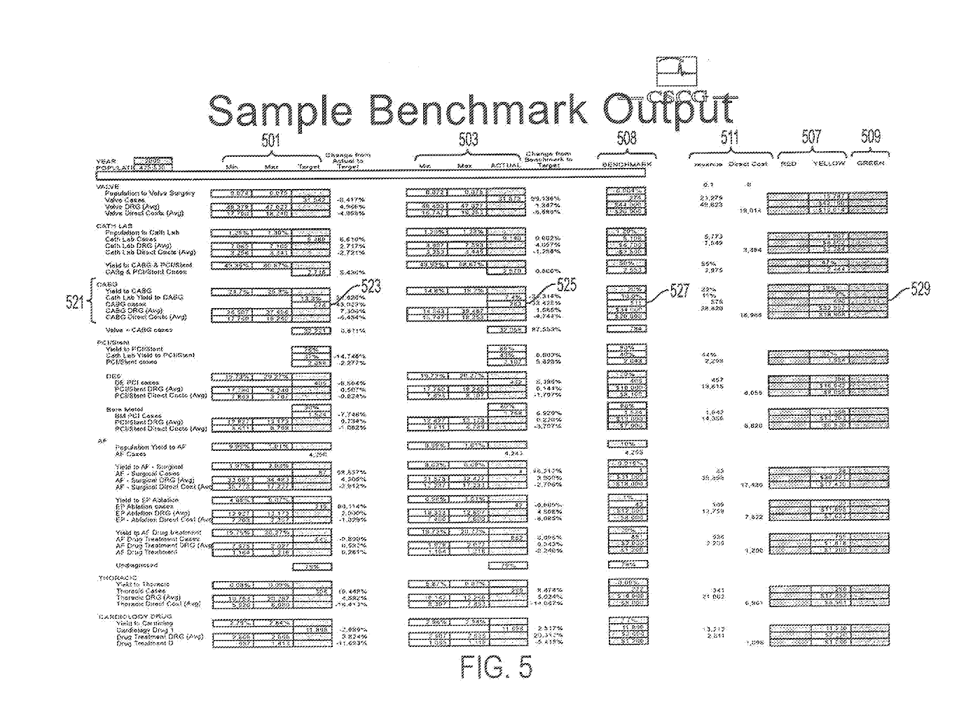

Once each procedure's evaluation is performed, multiple procedures can then be divided and categorized based upon the specific service lines of the provider. These can then be compared for benchmarking and for target setting. An embodiment of this categorization and comparison is shown in FIG. 5 where comparative values for various service lines are provided (501) and can be compared against what is actually being done (503) (i.e., the actual output) at the institution which is being investigated. This can then be compared against a benchmark or target (505) value. Problem areas are generally highlighted as either red (high concern), yellow (moderate concern) (507). Areas where the provider is meeting or exceeding a benchmark (509) may also be provided and are generally highlighted in green. To allow for a more robust analysis, the actual cost of making or failing to meet a target revenue and cost numbers (511) may also be provided.

For a more detailed explanation of the analysis, one can look at the CABG service line entry (521) of FIG. 5. In this exemplary embodiment, one can see that a high quality provider would generally have 679 cases where a CABG (523) procedure is performed. However, this hospital is only providing 383 (525). This is far to low for the population and potentially indicates that the hospital is performing too many alternative procedures (which, as contemplated above, may not be efficient in the long run) or they may be performing less valuable procedures while patients are substituting a different institution for the CABG procedure. A benchmark of 511 procedures is set based on what the computational models would predict the hospital should be performing based upon it's relative positioning and population from the econometric analysis of the information stored and obtained from the disparate databases. A range of 484 (528), the red value, to 490 (526), the yellow value, would leave cause for concern. A value of 518 (529) however would mean that the benchmark had been satisfied and that the provider was experiencing solid growth in this area, implying that the provider is on track.

While the Cath lab is merely one service line, Cath lab yield can be a valuable point of analysis. Establishment of a transparent national program for measuring and understanding cardiac cath-lab yields to various treatment arms could offer valuable information to assist in the management of coronary artery disease (CAD). Obviously, this same type of analysis can be repeated for other diseases or disease groups. This information is particularly important with regard to CAD because there is great geographic variation in the treatment of CAD. Thus, it is clear that no recognized “best practices” currently exist.

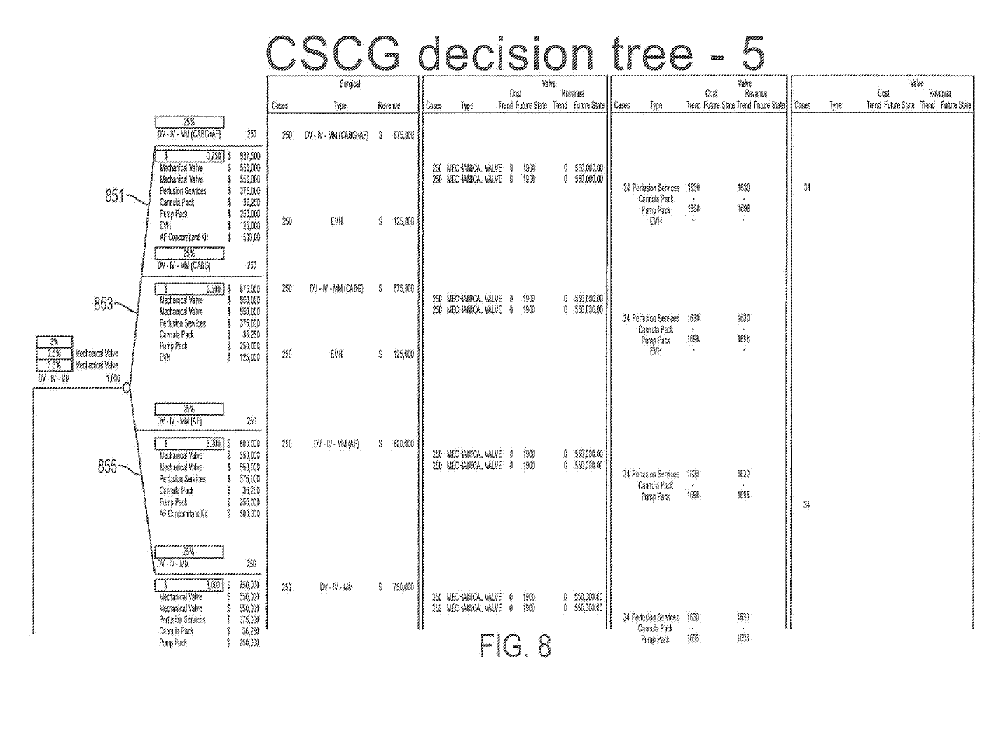

FIG. 8 helps to graphically illustrate the complexity of Cath lab procedures by showing a portion of a decision tree relating to specific cath lab procedures and how, even within a small subset of procedures, there is often great variation depending on specific patient and products used. In this specific depiction, three different procedures (851), (853), (855) are shown, each of which relates to mechanical valve replacements.

In addition to assisting individual providers in improving their own outputs, the analytical and predictive system discussed herein can also help to improve outputs across the on a national level, or even broader. By deriving an “Equilibrium Cath-lab Yield” (a dynamic and continuous measure determined by the effects of changing technology, evidence-based research, practice organizational structure, and personal practice patterns to determine treatment decisions for CAD), the analytical and predictive system can actually raise the standard of care provided across the country and, in fact, improve the quality of care and reduce overall cost by allowing for the most effective procedures to be used consistently. To use a simple example, if the data supported that in patients with underlying conditions A and B the CABG procedure provided a better return on investment, a hospital with a patient in that group should perform the CABG procedure with preference on that patient. Similarly, if for a different patient group, the stent procedure appeared to be the better choice, that procedure could be the weighted choice for that class of patients.

Because of the dynamic nature of the modern cardiac cath lab as well as the implied time-dependent nature of CAD, it is often difficult, if not impossible, for patients to obtain more than one opinion regarding treatment options. For effective health care decisions, the patient (and those paying the bill as well) must be made completely aware of the full scope and long-term costs and benefits of the various treatment options available in order to make a fully informed decision. If this opportunity is not provided to the patient, they may be led to make decisions quickly and will frequently proceed with a treatment plan without important information. In addition, often the physician administering the diagnostic tests is the same one delivering the specific course of treatment, thus leading to a potential agency (and bias) issues.

Similarly, being able to recognize that certain patients are more likely to react best to a certain procedure, a hospital with a population weighted toward those patients can also gear its practice toward preferential performance of those procedures. This can lead to further cost reductions (and quality improvements) as economies of scale and improved performance on those procedures begins to further improve the bottom line. In the long run, one could see each hospital becoming the best choice for the types of procedures that its expected population is most likely to have.

“Cath lab yields” can vary significantly among providers both within and between geographic regions, and these yields are neither well defined nor tracked on a provider or national basis. The “equilibrium cath lab yield” is a simple ratio with a remarkable impact, providing transparent best-practice information and a rigorous, disciplined approach to support a comprehensive and consistent standard of care that can be consistently measured as an alternative to the ad hoc processes currently employed. “Equilibrium cath lab yield” could best be defined as the optimal best-practice, evidence-based diagnostic-to-treatment option ratio when all potential conflicting biases have been normalized and when the patient has been made “fully informed” by their treatment team.

Thus, there is provided an equilibrium cath lab yield or a national and regional measure in which providers individually work towards maximizing patient outcomes as a whole and providing the transparency required for different stakeholders, including providers, patients and payers, to keep one another in equilibrium by leveraging the free flow of information to make systematic comparisons of results and to create a coherent vision to support learning, improvement, optimal patient care and clinical outcomes.

In addition to providing for cost measures, it is also possible to provide for quality measures and hybrid measures. Obviously, while certain procedures may cost less, if they fail to provide a sufficient improvement to health, there is no point in performing them. Further, while FIG. 5 provides for items across services lines, it is also possible to analyze the data using other groups, such as specific medical clinicians.

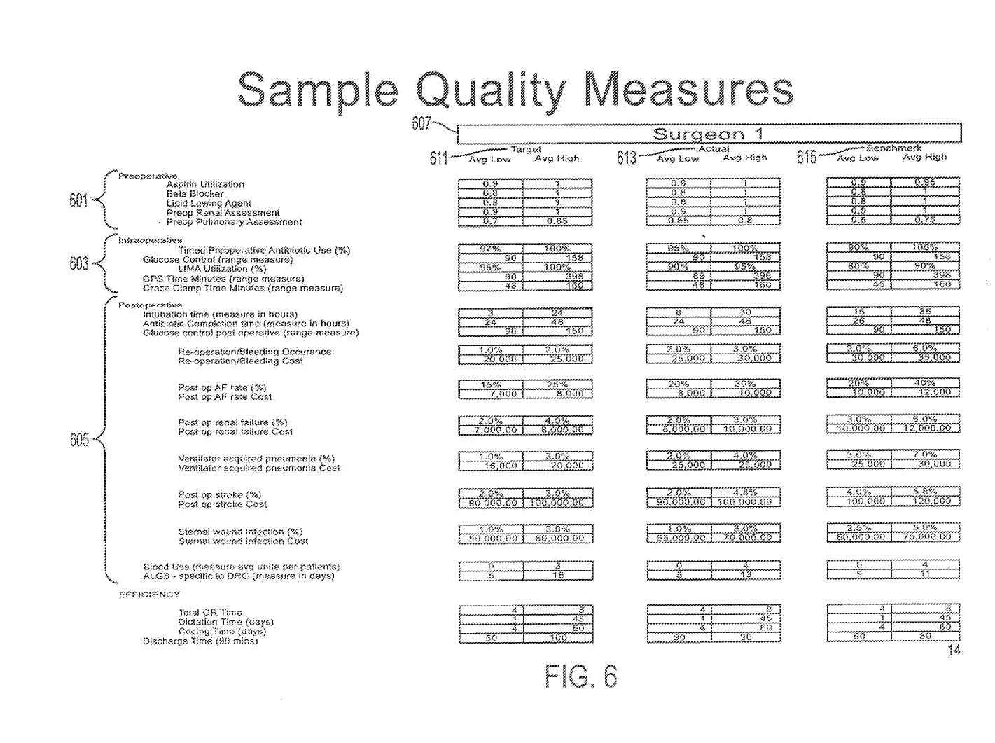

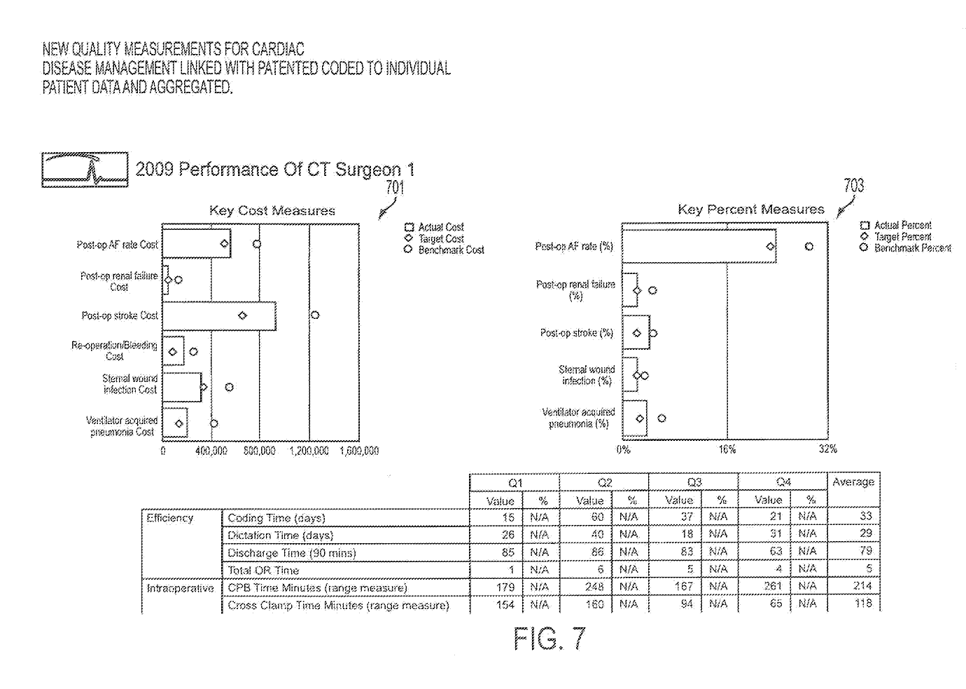

An embodiment of a quality evaluation for specific doctors is shown in FIG. 6. In this embodiment, a specific surgeon (607) is provided with targets for preoperative (601), intraoperative (603), and post operative (605) actions for a specific procedure. Again target (611), actual (613) and benchmark (615) values for each of these actions are provided. FIG. 7 provides an embodiment of an alternative display of performance for an individual surgeon which shows their relative performance vs. various cost targets (701) and quality targets (703). Use of such analytics can identify clinicians who may perpetually underperfrom, as well as those clinicians who consistently meet the benchmarks for the procedures and services they provide.

From the above, there are provided herein systems and methods that provide service lines and near real-time access to the multiple and complex sources of service-line data that supports the monitoring of progress towards the goals derived from an econometric model which can benchmark based on established provider performance in similar markets and environments. The systems and methods collect data for multiple business activities from diverse sources, and facilitate the delivery of accurate and timely answers to business questions to support informed decisions about budget planning, resource allocation, investments, expansion, and diversification. The systems and methods use validated actual data (as opposed to possibly biased research data) collected by an entity (e.g., hospital or insurance company) to provide an improved measurement of treatment results, compared to clinical trials that often have a bias built into the study (e.g., sponsor, funding, protocol development, inclusion exclusion criteria, patient willingness to participate, etc).

As should be clear from the above, in addition to providing the analysis system, it is also necessary to provide herein systems and methods that can aggregate and analyze data from a variety of validated databases that store empirical, financial and historical information (such as, but not limited to, Society of Thoracic Surgeons, Medicare, NY State database) and compare it to other validated but dissimilar databases which contain a blend of empirical and level A data (such as, but not limited to, the American College of Cardiology) for the purpose of understanding and effecting a disease along a more complete continuum of care, and then combining the aggregated and combined data with data from other hospitals on a regional or a national level, corporate or national data or a more complete understanding of financial and clinical outcomes data.

While the above discussion regarding the disclosed analytic and predictive modeling system discusses the modeling in conjunction with how analysis can be performed once data is obtained, it should be recognized that getting the data into a consistent and universal machine readable format can be difficult. Information on procedures performed, outcomes, and costs can be stored in a variety of different formats and manners. In FIG. 9, this is illustrated by the disparate databases (801) in which data can be stored. As noted previously, these external databases contain medical data, financial data, historical data, diagnostic image data and A level data in disparate formats. In order to place the data in a useable format, the data is extracted and transformed (803) into an unitary format which can be used in the aforementioned analytical processes of the disclosed system. The data is also aggregated, classified by a specific medical procedure or service line, and summarized (807) to provide for a finalized data warehouse (809) which can be used foundation for the analytical processes described herein. The analysis, as discussed above, is then performed (811) on this standardized data.

As noted previously, a large number different source databases (801) can be used to provide data. Generally, these will be data storage organizations or hospitals themselves. These can include, but are not limited to: the recognized American College of Cardiovascular database for measuring and quantifying outcomes and identifying gaps in the delivery of quality cardiovascular patient care in the United States, the Society of Thoracic Surgeons database in the areas of adult cardiac, general thoracic and congenital surgery, and the specific administrative and clinical data from hospital source systems. These exemplary empirical and historical databases would generally be used to evaluate cardiac procedures, such as the CABG and stent procedures discussed above. Other possible databases include those that store/contain financial information for medical procedures and level A information such as the databases for peer-reviewed journals and studies.

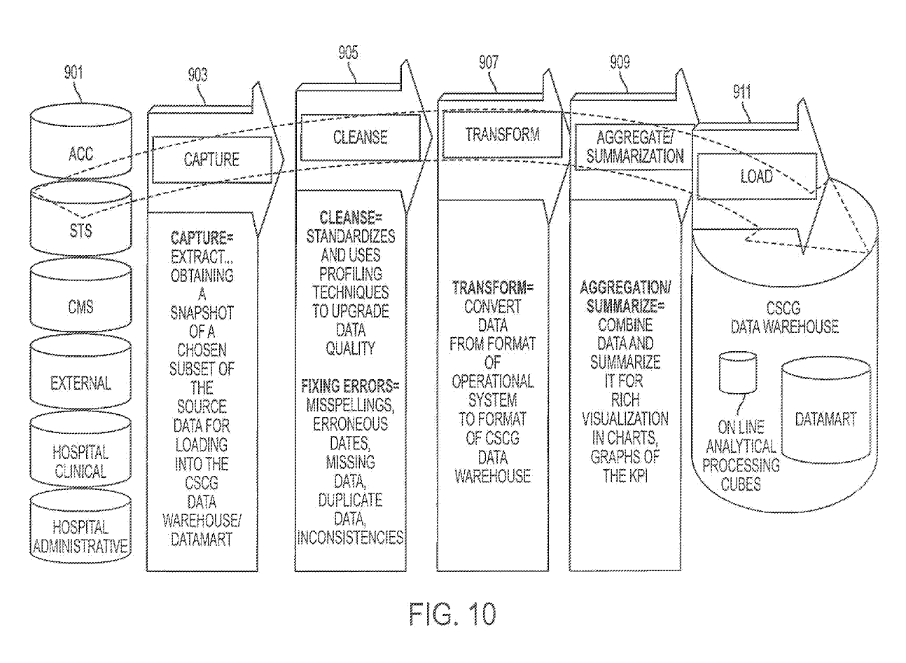

FIG. 10 provides for a general flow diagram illustrating conversion of data from the disparate source databases into the universal data warehouse. As shown in FIG. 10, the data starts in the disparate databases (901). Each database is accessed by a computer associated with the database. The computers associated with the databases are connected to a computer associated with the data warehouse via a network. Each database contains a data set associated with medical data, financial data, empirical data, diagnostic image data, clinical data, historical data, and/or published medical evidence.

In an embodiment of the computer system for the consolidation of medical and financial data disclosed herein, in a first step, the computer associated with the data warehouse sends a request for the data sets to the computers associated with the databases via a network. The computers associated with the databases receive these requests and then capture and retrieve the data sets from the databases (903). Then the computers associated with the databases then transmit the data sets to the computer associated with the data warehouse. Once the computer associated with the data warehouse receives the data sets, the data sets are automatically cleansed or transformed into a unitary data set (905). In this step, the data sets are standardized and a profiling technique is used to upgrade the data quality. At this step, errors in the data sets such as misspellings, erroneous dates, missing data, duplicate data and inconsistencies in the data are fixed. Stated differently, the data is cleansed to standardize units and other information, to make sure that there are no data errors and to correct any omissions or spelling errors which may result in a problem later. The data is then transformed (907) and converted from the format of the operational system to the format of the data warehouse. Then, in the next step (909), the data sets (which are now in a standardized format) are aggregated, classified and summarized. Generally, the data sets are classified by a specific medical procedure classification system known to those in the art to create a final data set. On example of such a classification system is to classify data in the data sets by Medicare Severity Diagnosis Related Group (“MSDRG”). In a final step (911), the final data set is stored in the data warehouse, where it is retrievable by its classification or by some other characteristic, such as, but not limited to, the classification or the medical clinician who provided the service.

It should be recognized that the specifics of the conversion will generally be unique to each database as the data in each database will be stored differently. However, once the method for conversion of each database has been determined, the specific conversion code and instructions can continue to be reused for that database over time. That is, the key factors and information will generally always be stored in the specific target database and will be universal within that database. For each such database, once the target data location has been identified, it can be collected using the same conversion in repeated cases.

In the event that certain data is not stored in certain databases, that data can either be left blank and not used (e.g., the particular entry does not count for analysis which utilizes that data point) or the data can be estimated utilizing estimation techniques. Further, in at least one embodiment, lack of complete data can be dealt with utilizing the Monte Carlo or similar simulation analysis where lack of data points is not as important.

While the above has contemplated how the data and information provided herein can be used to improve accounting and similar quality evaluation of a hospital in determining how to select procedures done and the value of certain types of procedures for certain patients, the system can also be integrated with other systems to provide for further improved cost flow. In effect, performing the most cost effective procedure results in no profit if the hospital is unable to collect on the bills it incurs.

As the system provides for improved recognition of procedures performed and integration of hospital based information, it can also provide for improved information for a patient and improved billing. The system performs this through a method of cost accounting, clinical outcome measurements, and predictive modeling business intelligence software tools for an integrated disease information technology system for automated monitoring, analysis of clinical and financial outcomes data.

After more than 15 years of hit and miss Electronic Medical Record (EMR) applications, there is a renewed interest in the subject. One of the biggest problems with the use of EMRs is portability and access to the patient. Patient controlled records can make critical records available much sooner to a provider, and can be used to help guide treatments using the software tools to aggregate evidence from the database contemplated above.

This medical record is called a Personal Electronic Medical Record (PEMR) herein. The PEMR is preferentially created when a “triggering event” (e.g., heart attack, cath lab procedure, or any other event which sends the patient to a medical provider and starts a longer course of treatment) sends a patient to the provider. The decision by the doctor and the patient to create a PEMR can be enhanced with financial and clinical incentives. In certain embodiments, doctors generally will use the triggering event and automated set up of the patient's account using medical society approved forms such as STS and ACC registry forms, that are abstracted as the basis for the initial set up of the record to accelerate, adoption and acceptance.

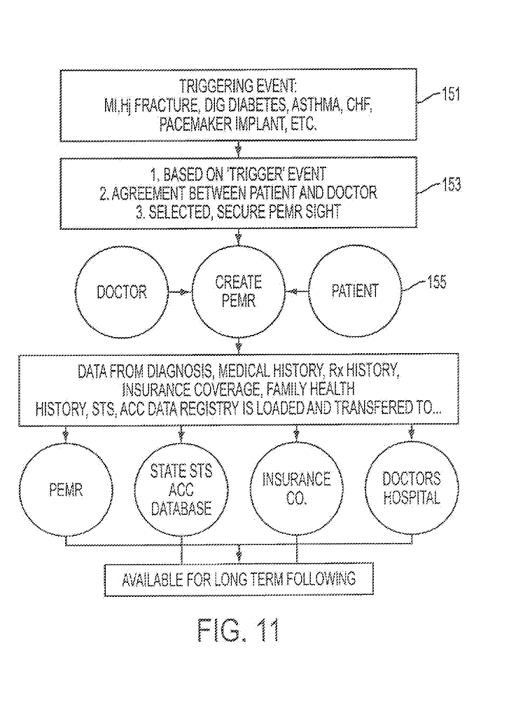

FIG. 11 provides for a general block diagram of a PEMR creation. In the first step (151), the triggering event occurs to the patient which sends them to the hospital or another medical service provider. Once there, in a second step (153), the patient and the doctor reach an agreement to setup a PEMR. Generally, this will be based on the triggering event so that associated medical information can be easily updated. At this time, the PEMR site is selected and secured.

Once the patient initiates the use of his or her PEMR, health care providers (also referred to as the interested parties) and the patients themselves can add to the PEMR electronically in a third step (155). The PEMR has the ability to accept data from remote devices such as, but not limited to, computers, Smartphones, tablet computers, PDAs, and other remote devices known to those of skill in the art. The idea is that the PEMR becomes a universal record, under the control of the patient, which includes all of the patient's healthcare information such as procedures performed, doctors they are currently seeing, insurance information, and specific medical records such as images, X-rays, lab results, etc. Data can also be passively provided to the PEMR from the interested party's database or other data sources based upon the data aggregation system disclosed previously in this application. Thus, if the patient goes in for a surgical procedure and provides their insurance information as well as primary care physician information, any information about the patient, the patient's medical conditions, or the procedure to be received by the patient stored in a third party database linked to the system, no matter what format it is stored in, can be updated to the PEMR.

The PEMR thus gives patients access to all of their medial records related to their triggering event. It is contemplated that the PEMR will grow over time to include additional information from other events and/or preventive care received by the patient. As the PEMR is under the control of the patient, the patient has the power to readily and efficiently gain second opinions based on his or her personalized comprehensive record and guided by links made available to the patient that lead to pre-approved information made available by his or her, physician, hospital, insurance company, Medicare and the FDA, among other relevant healthcare related entities. Furthermore, insurance companies can use these records to communicate critical information to patients regarding chronic diseases and lists of “in network” healthcare providers and newly covered treatments.

Generally, the PEMR will exist on a secure web site such as “myPEMR.com” or in an electronic format that the user can carry with them to the doctor such as, but not limited to a portable hardware device or piece of storage media, such as a flash drive or a jump-drive, or a tablet computer, e-reader, smart phone, PDA. Preferably, the PEMR will utilize standard software known to those of skill in the art to create the EMR. The PEMR will be stored on a secure site generally accessible network (such as the Internet) and can be accessed utilizing a registered username and password combination known to the patient. The patient can then grant access using a “friending” (or ask/confirm) function or similar security interface; the patient gives consent for a given provider to have access to their PEMR. Specifically, in an embodiment, the PEMR access will utilize an ask/confirm interface to allow for the PEMR to be shared. Those wishing access to the PEMR (i.e., an interested party) will send a request to be granted access which can be reviewed by the patient and confirmed if the patient wishes to grant access to the requesting individual or entity. Thus, a patient user would have a PEMR “friend” (doctor, family member, insurance carrier, etc.) page as is used in a variety of social network software programs such as, but not limited to, Facebook®, Twitter® or Linkedin®.

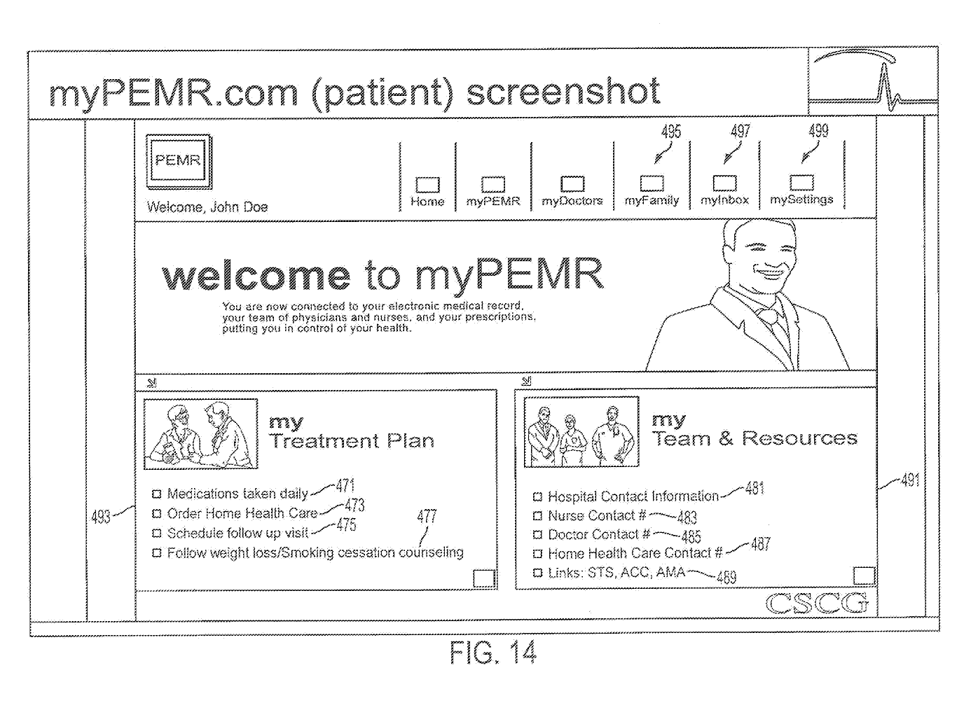

In one embodiment of the PEMR disclosed herein, access to the PEMR can be carried out as follows. The patient would have password or other secured access to the PEMR whereby they control external access to it as well as being able to modify or add to the information therein. When the patient goes to a doctor or other provider for the first time, the interested party/doctor, if they use the PEMR system, would be able to request that the patient provide them access to their PEMR by sending them a request from a verified “doctor” account. This would be an electronic message which would be sent directly to a messaging system, such as but not limited to an e-mail, instant message, chat, or Twitter® system, within the PEMR system and accessible via the “patient” account after the patient's user identity has been confirmed (e.g., with the inbox (497) in FIG. 14). When the patient logs into their PEMR, they will see the request for access by the specific doctor account in their inbox or applicable messaging system receptacle. The patient can then review details of the request (which may include a password, identifying information from the doctor account, or even encryption keys or similar technologies to confirm that this doctor should be granted access) and accept or decline access. Once access has been granted, the doctor, when logged into their “doctor” account would then be able to call up shared portions of the PEMR for their use and can add information to the PEMR regarding their treatment of the patient.

This embodiment of an ask/confirm interface to grant or deny access to the PEMR can be particularly useful where multiple different EMR software is available for use by the patients and doctors. In effect, the system can act as an intermediary to allow patients and doctors to use software they are comfortable with while still allowing for interconnection between unlike systems. The ask/confirm process allows the system to load an appropriate piece of conversion software which can intermediate between systems with different formats. Doctors and patients can also ask/confirm selected sponsors or advertisers or other interested parties to supply materials and/or medical information based upon a list of preferences the patient or confirmed doctor establishes in the “settings” section of the PEMR.

In another embodiment of the PEMR, it is contemplated that a “Premium Level” can be created in the PEMR. In this Premium Level, users who are willing to pay additional fees will be able to gain superior access to second opinions, help nurses, medical assistance and opinions and special features to help them better manage their medical choices and medical conditions.

In another embodiment of the PEMR, the ask/confirm interface can provide for further ease of use as the patient gets referred. Especially when there is a medical incident, it is likely that a patient may go through a number of different doctors, many of which may be new to them. Specifically, they may start with an admitting physician, then go to a specialist, and finally go back to their regular doctor and possibly get someone to assist with recovery. Each of these doctors may not have prior access to patient's medical record and will often need access to the patient's medical records at sometime during the course of treatment. With the referral, the original doctor can notify the referred to doctor of the referral, if that doctor is accepting new patients they can then contact the patient in a similar manner as discussed above to request PEMR access to get access to these records, thus streamlining the exchange of medical information to new providers.

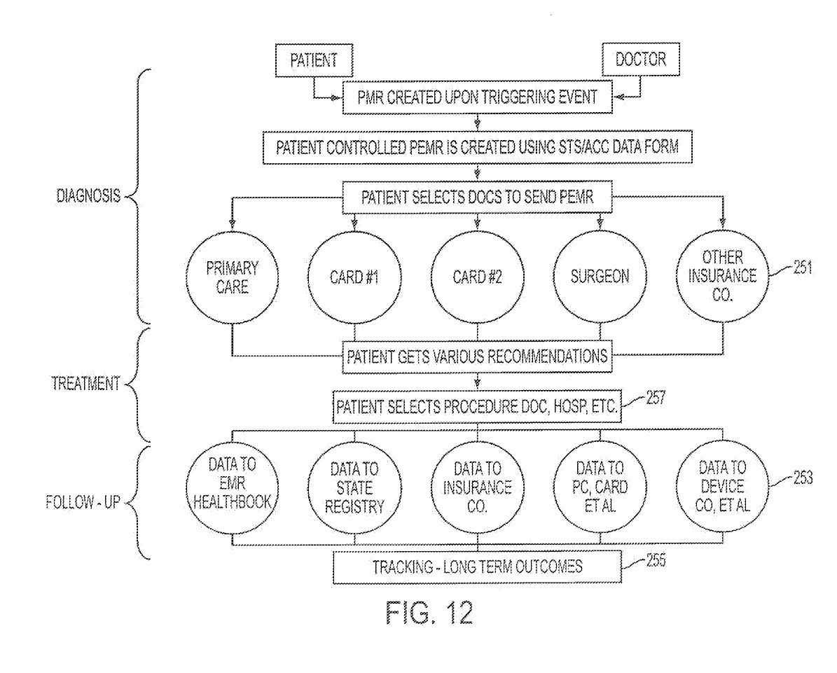

FIG. 12 illustrates how this information can be used with the PEMR to provide that information is shared between doctors where the patient can simply carry out the ask/confirm process with those that they meet and want to provide with access to the PEMR (251). Similar to gathering referrals, the patient can also allow requests from a number of different competitive physicians to get a second opinion on treatment options. From the information obtained, the patient can then select the specific doctors or care that they wish to use.

Should a doctor not be selected, or if the patient was to move to a different doctor, the patient can “defriend” (that is revoke access) to those that they are not using (257). By this action, access to the PEMR for individuals that are no longer involved in the patient's care is revoked. Similarly, as the system grants access only while the doctor is needed (and can allow them to upload additional information in that time) the PEMR is maintained with complete information and the doctor does not need to store the records on site, saving them the cost and expense of doing so. Further, records for discontinued patients are not destroyed or lost in filing.

During the procedure and follow-up, information on the procedure may be supplied to the PEMR by any individual acting with the patient, or by the patient themselves, and then can be provided to those others that are in need of it (253) immediately upon upload. Finally, once the procedure is entirely complete, long term follow-up (such as for a recurrent situation) can also be carried out (255).

FIG. 14 provides an embodiment of a home screen of a patient PEMR record once the patient has passed through security verification and now access their material. As one can see, the screen principally shows a box indicating the doctors that are currently in use (491). This includes references to specific hospitals (481), nurses (483), doctors (485), and home health care professionals (487) and links to associated organizations (489). There is also shown an indication of treatment (493) which includes links to medications (471), home health care (473), scheduling (475), and counseling (477).

These two blocks of information are merely an exemplary interface design for the home screen of the PEMR, but provide for the types of information which can be included in a PEMR and accessed by a patient. In order to provide for other information, additional sources, such as those indicated on separate page tabs in FIG. 14 can also be provided. For example, a tab (495) can provide links to family members and related individuals who may have power of attorney, be able to make certain healthcare decisions, be next of kin, or may simply have been granted access to the confidential health information of the patient.

Similarly, a tab may be provided to the incoming messages receptacle (497). From this tab, the patient can view incoming messages from physicians or other healthcare practitioners who wish to be granted access to the user's PEMR and to allow/disallow the granting of viewing rights. It is also contemplated that a user could view the transmittal of confidential information to and from the PEMR from this tab (497). A settings (499) tab may also be provided to allow for reconfiguration of appearance and formatting of the PEMR, modification of password, other information or other general computer operational information as known to those of ordinary skill.

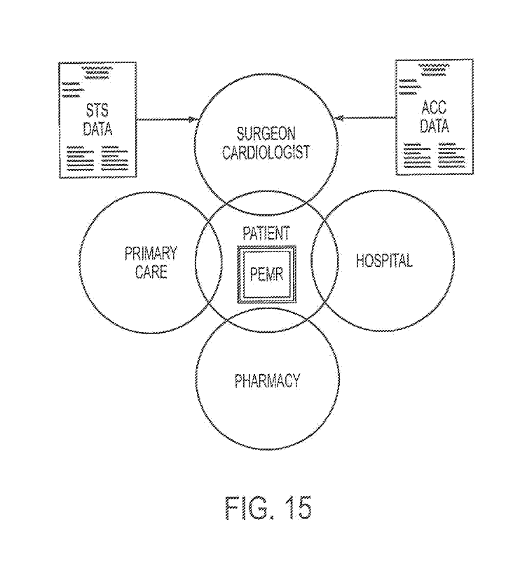

As shown in FIG. 15, it is contemplated that the PEMR, in conjunction with other aspects of the analytic and predictive modeling system, can allow access by the patient, hospital, insurance company, Medicare, state databases, surgical and cardiology databases to the patient information. Thus, information may be pulled from multiple sources to supply the patient with a better picture of potential treatment options. Similarly, the analytic and predictive modeling system, as discussed above, can also operate on this specific patient's information to provide suggestions for care. Similarly, the PEMR can act as a single database entry for that patient allowing the analytic and predictive modeling system discussed above to utilize the patient's specific circumstances in its evaluations and pass on information between the care providers because of their common interest in the same patient.

A PEMR including such broad information can also provide benefits to physicians and other providers that utilize the PEMR as it can enable them to pull up health insurance and similar information without need for them to enter it into their own systems and to deal with updates or additional information. This can simplify the complex healthcare billing process as it provides information indicating how to contact appropriate payers for the healthcare services provided. Specifically, an insurance provider that is attached to a particular patient can have provided details of the specific insurance and can provide indications of costs it will reimburse and care it thinks is acceptable in a specific situation.

This can provide both the patient, and potentially the healthcare provider, with financial consideration information. Thus, if the patient is diagnosed with a particular condition, the patient can review the recommended treatment options provided by both his/her physician and those second opinions they may wish to obtain, can obtain analysis and supporting information from the decision engine, and also obtain indications of actual costs borne by the insurance company and charged by the provider. This can assist them in making a more informed decision in their healthcare choices.

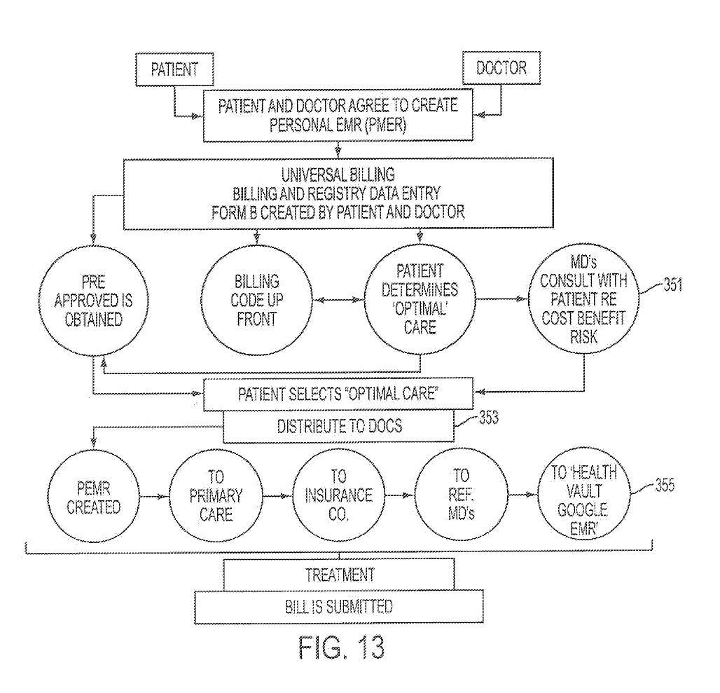

Further, as shown in FIG. 13, billing can be carried out up front using the PEMR, which can greatly simplify reimbursement for the healthcare provider. Since the patient has the ability to consider treatment options as well as what the insurer will cover (and how much) with each treatment option (351) this can be part of the patient decision (353). Further, since the billing is handled up front, there should be no concerns or disagreements over the resulting bills and payment. The physician knows who will be paying what portion of the bill for the selected treatment and can automatically issue invoices that they know are more likely to be honored. In a further embodiment, the patient (and the insurance company or other payer) may provide for automatic billing mechanisms. Thus, when the patient selects a treatment and has it performed by the doctor, the doctor need simply update the PEMR indicating that the procedure is complete. Invoicing and reimbursement from all parties may automatically be carried out for the agreed upon amount in an embodiment.

In other embodiments of the PEMR, patients, physicians, hospitals, and insurance companies will be able to add advanced communication features including, but not limited to, health care budget information (e.g., what a provider has paid for care so the patient can know what the patient paid for insurance and what the provider, in turn, paid for care); a budget for prescription and over the counter medications (including co-pays), so doctors and patients can make sure the patients on budgets are spending money on the most critical medicines; follow-up care instructions; preventative care; family history/risk factors; weight loss program tracking, etc.

In conclusion, there are provided herein, among other things, an analytic and predictive modeling system for predicting and monitoring a specific disease states using a predictive model combined with a data acquisition software program

There is also provided a method for forming an integrated database from dissimilar medical areas (cardiac surgery, cardiology, cath lab, pharmacy, insurance company) for the purpose of creating a single patient view, hospital view, or selected view, with cost measures and outcomes measures integrated into a single data base.

Further, there is also provided herein a PEMR controlled by a patient and generally created at a predetermined “trigger point” (incident) that is determined by the payer, patient, and/or healthcare provider.

In addition, there is also provided a method of connecting and forming the PEMR to an existing or future EMR system. This may include a patient homepage with preset links to his or her doctors (cardiologist, oncologist), insurance company, device makers (e.g., Pfizer), and hospital or other healthcare provider for pre-post treatment information, and present links to approved information. This page will generally provide secure patient access.

There is also provided a method for automatically downloading patient data from a doctor, hospital, pharmacy, or payer, via “push” of data to patient or “pull” (i.e., STS, ACC, Rx data, etc. download automatically or by ask/confirm from the patient). The patient, before going to see a doctor, will “friend” that doctor, giving the doctor access to their PEMR. Thus, the patient will be able to control what doctors access their file, and patients can also restrict access to certain data. The patients and doctors will be able to access the PEMR just as one can access secure data from a number of different mediums. For example, the patient will be able to access it via the Internet from a home computer. However, they will also, preferably, be able to access it via an Iphone® or similar mobile application. Furthermore, if the doctor is not in the network, the patient can download their records from the Internet. This will allow the patient to put their record onto a flash drive or print it out to bring it to a non-networked doctor for a second opinion. This network also can create an electronic referral network, where patients will have access to doctor's (pre-selected, based on insurance coverage or other parameters) pages.

In an embodiment, patients will be able to search for doctors by the type and location of doctor. When the patient logs onto the doctor's page, the patient will be able to see testimonials, as well as personal information about the doctor, including education, experience, and areas of specialty. There will also be a referring tool, which will allow doctors to log on and refer a patient to another doctor. Thus, doctors will be able to see what doctors are referring what patients to their offices. This is a helpful feature for long-term patient outcomes tracking, because the patients are accessible through the Internet by whoever the patient has allowed to track their outcome. As patients change doctors they can still elect to have their outcome tracked by Medicare, the STS, the ACC, or any other database or monitoring service.

There is also provided software code for a system of “links” that provide a transparent view, with predetermined authority levels and control of hospital data, patient data, and payer data for the purpose of improving specific disease state cost and outcomes, while maintaining patient confidentiality.

There is also provided a method of creating a provider specific predictive model to enable a hospital to extract a small subset of data and automatically produce a clinical and financial plan for a service line.

There is also provided a method for tracking a selected parameter such as a referral from a cardiologist to surgeon and automating the process based on cardiologist and patient criteria (e.g., MD's, off pump, mitral valve repair, or ablation method)

There is also provided a method for patients to track and maintain what surgical products are used and what medications they have taken, in order to protect them from harmful drug interactions and notify patients immediately regarding recalls or similar concerns. Furthermore, patients (such as those with pacemakers) will be notified if a version of their pacemaker is involved in a recall, but not the model number they have saving doctors and office staff valuable time. They can even be reminded that a procedure to replace a battery or similar consumable should be scheduled.

In a “Premium” membership, the patients or doctors may receive automatic updates from a selected list of companies, such as a pacemaker company that has the ability to automatically download data regarding normal hearth rhythm, ICD activation and Atrial Fibrillation and when a battery is due to be changed. In this example of PEMR, dashboard or similar displays will be used to provide doctor and patient an instant indication that everything is “green light” or “yellow light” in the case of an aging battery. This notification may be on any media, such as, but not limited to, telephone instant message, automated email message, a myPEMR.com message, or another message type as known to those of ordinary skill

There are also provided Automated Admission Templates (AAT) to capture important medical, social and demographic information on a patient specific basis and a medical profile, living document, flexible/custom sizable, user-friendly interface, transportable including integrated billing capabilities automatically updated and adjudicated with clinical data predictive modeling based on above clinical, social, and demographic data format variability (outline format, executive summary format, detailed drill down format).

In another embodiment the “AAT” will be created to be consistent and leverage current medical registry data bases such as STS and ACC. In an advancement over what is currently available users will add their own special fields of information, such as referral information, primary care doctor, preferred pharmacy, and patient consent to participate in the PEMR, and passwords used in PEMR initiation.

In a further embodiment a nurse with a laptop, pda, or Iphone® or other portable electronic device will allow the patient to secretly type in their password and other data as they are admitted or as they are prepared for a procedure. This can act as the patient's signature of the consent for the procedure and PEMR.

There may also be provided automated pre-op evaluation/checklists which can interface with record systems to indicate medical condition(s) requiring surgery, site/side of proposed surgery, required pre-op testing specific to proposed surgery, concomitant/associated medical conditions, surgeon, date, time and other records. After surgery, automated operative records can provide format standardization for common procedures with custom data fields loaded with necessary and sufficient clinical data to link with specific specialty clinical data base; administrative data base for accurate and real time coding, billing, cost information, utilization, efficiency, and productivity in a variable format (outline format, executive summary format, detailed drill-down format) and automated discharge summaries can provide event specific medical/treatment summary (outline format, executive summary format, and detailed drill-down format).

There is also provided herein Automated Extraction, Transformation, and Loading (ETL), processes, to link medical, procedural, surgical, interventional, imaging data and associated utilization with supply chain/inventory and their respective cost data and a data mart/warehouse that is uniform/standard and able to interface (ETL) with all enterprise specific EMR System Platforms.

Patients could access/plug-in to individual and standardized data mart and extract specific health information and upload onto a personal device or provide it in a standardized format into and out of the various EMR system platforms.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A computer-readable memory storing computer-executable instructions for storing and accessing a patient's personal medical record on a computer network, the memory comprising:
computer-executable instructions for storing a dataset comprising a personal medical record of a patient created by a medical provider on said patient's authorization, said personal medical record being controlled by said patient;
computer-executable instructions for identifying a user trying to access said personal medical record as said patient;
computer-executable instructions for allowing said patient to review, add to and modify said personal medical record after access to said personal medical record is granted to said patient via a network;
computer-executable instructions for allowing an interested party to request access to said personal medical record from said patient;
computer-executable instructions for allowing said patient to accept said request for access to said personal medical record, wherein if said request is accepted, then said interested party can access, add to, and modify said personal medical record;
computer-executable instructions for allowing said patient to revoke access to said interested party after said request has been accepted, wherein if said access is revoked, then said interested party can no longer access, add to, and modify said patient's personal medical record.

2. The memory of claim 1, wherein said interested party is a physician, a healthcare practitioner, a health insurance company, a hospital or a healthcare facility providing medical care to said patient.

3. The memory of claim 2, wherein said dataset comprising said patient's personal medical record is created when said patient first visits said interested party, said personal medical record being created by said interested party at a point of care.

4. The memory of claim 3, the memory further comprising computer-executable instructions for automatically updating said personal electronic medical record with information relevant to said patient from a database associated with said interested party.

5. The memory of claim 1, the memory further comprising computer-executable instructions for transmitting non-personalized information from said patient's personal medical record to a third-party database.

6. The memory of claim 4, wherein said personal electronic medical record is passively updated with medical information relevant to said patient from said third-party database without an action being taken by said patient or said interested party.

7. The memory of claim 1, the memory further comprising computer-executable instructions for providing said patient access to a premium level of services, wherein if said patient pays a monetary fee, then said patient can access said premium level of services.

8. The memory of claim 1, the memory further comprising:
computer-executable instructions for receiving an invoice from said interested party;
computer-executable instructions for determining which portion of said invoice is the responsibility of said patient and which portion of said invoice is the responsibility of a third party payer;
computer-executable instructions for storing payment information of said patient, said payment information of said patient selected from the group consisting of: a credit card, a bank account, a money order, and an e-commerce payment account; and
computer-executable instructions for automatic payment of said patient's portion of said invoice with said payment information of said patient upon said receipt of said invoice.

9. A computer system for the consolidation of medical and financial data, said computer system comprising:
a medical database accessed by a first computer;
a financial database accessed by a second computer;
a third computer connected to said first computer and said second computer by a network;
a data warehouse accessed by said third computer;
a data set stored in said medical database, said data set comprising medical data; and
a data set stored in said financial database, said data set comprising financial data;
wherein said third computer requests said medical data set from said first computer over said network and said financial data set from said second computer over said network;
wherein said first computer retrieves said medical data set from said medical database and said second computer retrieves said financial data set from said financial database;
wherein said first computer and said second computer transmits said medical data set and said financial data set to said third computer;
wherein said third computer receives said medical data set and said financial data set;
wherein said third computer automatically transforms said requested data sets into a unitary data format and said second computer automatically associates data contained in said requested data sets with a classification corresponding to a specific medical procedure to create a final data set;
wherein said third computer stores said final data set in said data warehouse; and
wherein said final data set is retrievable by said classification.

10. The computer system of claim 9, wherein said classification corresponds to a medical service line.

11. The computer system of claim 9, wherein said classification corresponds to a Medicare Severity Diagnosis Related Group (MSDRG)

12. The computer system of claim 9, wherein said third computer requests a plurality of data sets from a plurality of databases, a plurality of data sets from said plurality of databases are transmitted to said third computer, said third computer receives said plurality of data sets and aggregates said plurality of data sets after said third computer transforms said plurality of data sets into a unitary data format.

13. The computer system of claim 12, wherein said plurality of databases contain clinical data, financial data, diagnostic images, published medical evidence and historical data.

14. A computer-readable memory storing computer-executable instructions for an analytical and predictive modeling system on a computer network, the memory comprising:
computer-executable instructions for capturing data sets from a plurality of databases;
computer-executable instructions for transforming said captured data sets into a unitary data format, said unitary data format associating said captured data sets with a classification corresponding to a specific medical procedure;
computer-executable instructions for collecting multiple data sets associated with classifications corresponding to a service line into an amalgamated data set;
computer-executable instructions for analyzing said single data set to produce a predictive model for average and best practices for said service line;
computer-executable instructions for receiving an individual provider's input variables in said unitary format for said service line; and
computer-executable instructions for comparing said predictive model to said individual provider's input variables to produce a decision tree for said service line for said individual provider.

15. The memory of claim 13, wherein said plurality of databases contain clinical data, financial data, A level data and historical data.

16. The memory of claim 13, wherein said decision tree is comprised of benchmarks, actual output and target output.

17. The memory of claim 13, wherein Monte Carlo simulation is used to produce said decision tree.

18. The memory of claim 13, wherein factors considered in said step of analyzing are selected from the group consisting of: expected patient population, frequency at which a procedure is performed, cost of a procedure, service line, population yield, average length of stay, volume of procedures, revenue of provider per procedure, direct costs to provider, and contribution profit of the provider.

19. The memory of claim 13, wherein said step of analyzing said data set is performed to produce a predictive model for average and best practices for an individual clinician and patient at the point of care, with recommendations for treatment.

20. The memory of claim 18, wherein said decision tree is comprised of benchmarks, actual value and target values in the preoperative, intraoperative and post operative stages of a specific medical procedure for said individual clinician.
